(19) United States
(12) Patent Application Publication
(10) Pub. No.: US 2002/0054079 A1
(43) Pub. Date: May 9, 2002

(54) Method and apparatus for creating audio media

(75) Inventor: J. Francis Russel, San Diego, CA (US)

Correspondence Address: Mayer, Fortkort & Williams, L.L.C., Suite 250, 200 Executive Drive, West Orange, NJ, 07052, US

(73) Assignee: Sony Corporation/Sony Electronics Inc.

(21) Appl. No.: 09/745,846

(22) Filed: Dec. 21, 2000

Related U.S. Application Data
(60) Provisional application No. 60/171,421, filed on Dec. 22, 1999.

(51) Int. Cl. G09G 5/00

(52) U.S. Cl. 345/738; 709/217

(57) ABSTRACT

A method of creating a downloadable and printable reproduction of the graphical content that accompanies published digital audio recordings. Data from an archive containing digital graphical content corresponding to a digital audio recording is downloaded and converted by software into an accurate printable reproduction of the graphical content that accompanies commercially available digital audio recordings.

### CROSS REFERENCE TO RELATED APPLICATION

This application is related to patent application Ser. No. 60/171,421, filed Dec. 22, 1999. This application is incorporated herein by reference in its entirety.

### FIELD OF THE INVENTION

The present invention relates generally to methods and systems for distributing data electronically, and more particularly to a method and system for electronically distributing digital graphic data, associated with digital audio data, to create audio products, such as Compact Discs (CDs).

### BACKGROUND OF THE INVENTION

The concomitant advent of digital audio and the Internet has made possible downloading of digital audio files from on-line digital audio sources or archives, in which digital audio data is stored. An example of a website that facilitates such downloading is http://www.napster.com.

The Internet and associated web browser plug-ins now readily available on line make possible a facility and methodology that provide a viable alternative to the traditional method of distribution and acquisition of digital audio, wherein a prospective purchaser is required to visit an audio retail establishment to purchase and thereby acquire the digital audio product. Currently, if desired, a prospective user or purchaser of digital audio or data can simply download an audio file from the Internet, or other available digital archive, for example, and transfer the digital audio to a blank compact disk (CD) using a CR writer. The downloaded audio file is a digital replica of that which is available for purchase in a retail establishment.

While the transmission and downloading of digital audio data is becoming more widespread and commonplace, the same cannot be said for the graphics that accompany present day digital audio recordings. For example, when a CD is purchased from a retail establishment, the packaging contains the CD, a protective container and graphics containing information pertinent to the audio recording. The graphic information that accompanies a digital audio recording typically comprises uniquely identifying features, such as pictures of the recording artist(s), copyright information, a UPC barcode, title of the recording, publisher's logo and song/track listings.

Unfortunately, outside the traditional retail establishment purchase context, wherein a purchaser goes to an establishment to purchase a published recording that contains corresponding graphic material, the on-line acquisition of an accurate reproduction of graphic material that accompanies published audio recordings is not currently possible. In short, a means of acquisition of graphical material that accompanies digital audio recordings analogous to that currently available for downloadable digital audio as discussed above does not exist. While it is possible for users/purchasers to create a “homemade” graphic to accompany downloadable digital audio using commercially available software packages, a method for the replication of the original graphic material that accompanies the original recording when published is not currently available. In short, it is currently not possible to replicate audio sources that are available from traditional distribution channels using the Internet.

The present invention is therefore directed to the need for a method, system and apparatus for downloading over a computer network, such as the Internet, a complete audio source that can replicates the graphical content that accompanies digital audio recordings that are available from traditional distribution channels.

### SUMMARY OF THE INVENTION

The present invention solves these and other problems by providing a method, system and apparatus for downloading graphical information related to an audio recording, which can then be used to recreate the original packaging graphics information.

When used in conjunction with known methods for downloading digital audio recordings, prospective purchasers or users will be able to replicate a complete audio with accompanying graphics, from a digital archive, without the need to visit a conventional retail establishment.

The present invention enables digital audio purchases or acquisitions that can be entirely performed by accessing a digital archive from a number of point sources, such as the Internet using a personal computer (PC) or suitably configured retail kiosks. Thus, a prospective purchaser or user can access on-line digital archives via computer and procure digital audio and corresponding graphical material without leaving his or her home or visit a kiosk or retail station to perform the digital transfer.

### BRIEF DESCRIPTION OF THE DRAWINGS

FIGS. 1-13 show various schematics and software application screens detailing the method of the present invention in various stages of processing.

### DETAILED DESCRIPTION

The present invention includes inter alia a method and service for enabling a complete audio source to be downloaded from the Internet or other digital archive. Using existing technology to download the audio files in combination with a method for downloading associated graphic information, the present invention makes possible for the first time the complete replication of audio source media, as they exist in stores. The method and system include processing digital graphical data stored in an on-line digital archive or other digital storage medium, such as a CD-ROM disk or digital video disk (DVD).

At this point, it is worthy to note that any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment.

System Overview

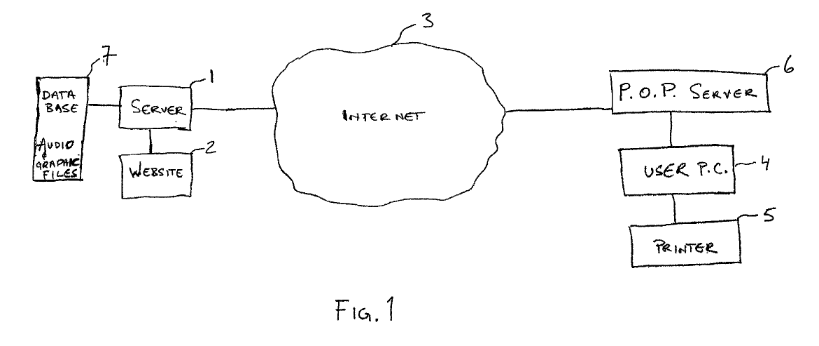

An exemplary embodiment of a system according to the present invention for implementing one aspect of the present invention is shown in FIG. 1. A server 1 hosts a web site 2 that can be accessed via the Internet 3 by a user operating a personal computer 4, which has a printer 5 coupled to it. The personal computer 4 is connected to the Internet 3 by Point of Presence (POP) server 6. The server 1 manages access to a database 7, in which is stored the audio files and the associated graphics files for multiple compact disks.

In general, a user accesses the server by directing his or her browser to a predetermined web site 2, which is hosted by the server 1. The web site includes a search engine that enables a user to specify a particular artist or title, which is then used to query the database 7 for information related to the search query. Multiple records may be retrieved based on the particular query and displayed to the user via the user's web browser. The user can then select one of the results by clicking on the link, which then allows the user to purchase the selected compact disk specified by the particular link.

Using conventional Internet shopping techniques, the user pays for the particular compact disk, which is then transmitted to the user over the Internet in two forms, an audio file and a graphics file. The audio file is then converted to a format suitable for transferring to a compact disk by a CD writer in a known manner. The graphics file is transferred to the user in a predetermined format, such as a PDF file, compatible with the software program QuarkXpress for example. The conversion of the graphics file to a printable format is discussed below.

Following the conversion of the graphics file, the user can print out the related graphics using a color printer, for example, onto preformatted paper configured to replicate the various parts of the CD packaging being replicated. Once the graphics are printed on the preformatted paper, the user simply folds or separates the paper along designated lines and inserts the paper with the printed graphics into a blank CD case, thereby creating a replica of a retail outlet sourced CD.

Graphics Conversion

According to an exemplary embodiment of the present invention, the graphical content of a digital audio recording, commonly referred to as a “CD booklet” and its associated elements, is stored in the database in a predetermined format that can be converted using a conventional software package or packages. One possible implementation of this exemplary embodiment employs three widely available software packages to convert the graphics information to a printable format. These software programs include “Quark Xpress,” “Adobe Acrobat Distiller” and “Adobe Acrobat Exchange.” While the disclosure of the methodology of the present invention will emphasize the specific use of these software packages, it is clear that to one of ordinary skill in the art, the invention of the present disclosure has applicability regardless of the specific brand of software used for its implementation.

Preparation of the graphical content to accompany a digital audio recording by the method of the present invention requires two basic component steps:

Content Acquisition and

Preparation of the graphic digital content.

Content Acquisition

The first step in the methodology of the present invention requires the user/purchaser to set up a directory and a Sub file, in which the archived digital graphic data resides during preparation. During the downloading process, the user specifies this sub file location on his system (e.g., hard disk drive), to which the file is written during the downloading process.

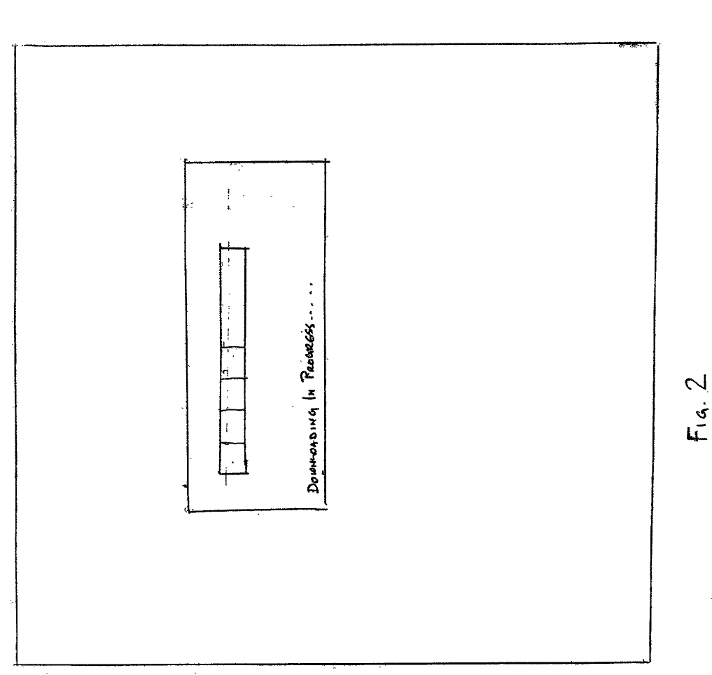

FIG. 2 shows a typical screen 201 for facilitating this task on a Macintosh PC (a similar screen is possible for a IBM-based personal computer). The content of the graphic content package is selected to be compatible with the software to be used to prepare the graphic digital content for downloading and printing.

Typically, the source material for the graphic digital data that corresponds to a digital audio recording should include at a minimum the following elements:

Original Layout documents (preferably in Quark Xpress format 4.0), including

All applicable fonts,

All line artwork (.eps files, logos etc.) and

High Resolution Imagery.

Following the directory and sub file set up, the graphic digital content source file, preferably in Quark Xpress document format can be opened in the assigned directory and sub file. Opening the Quark Xpress graphic digital content file completes the Content Acquisition step of the present invention.

Following the Content Acquisition step, the graphic digital content can be prepared for printing.

Preparation of the Digital Content

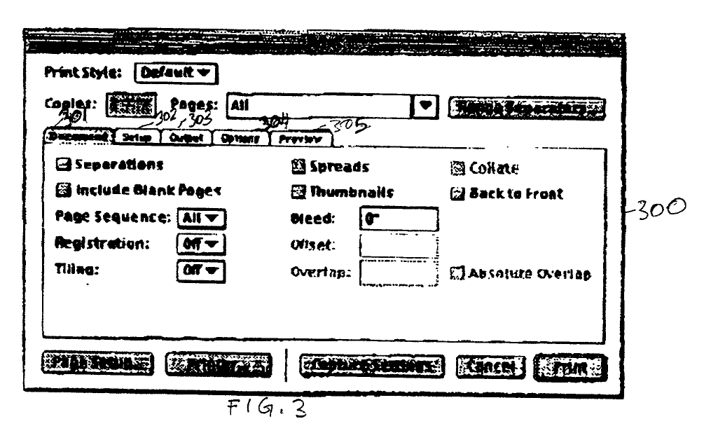

Following Content Acquisition and with reference to FIG. 3, the second step in the methodology of the present invention is the preparation of the digital content and the creation of a PDF file. It is necessary at this point to ensure that all required elements from the graphic digital content archive or source are included and are in the proper format to permit loading into Quark Xpress. These elements include all fonts, CD booklet (Inside/Outside in Quark Xpress format) element, CD Spine/Tray element and all high resolution artwork elements including image files, line art and recording label logo.

At this stage, a desired graphic digital element, such as the CD inlay, for example, or other loaded element (spine, etc.) can be selected and opened in Quark Xpress.

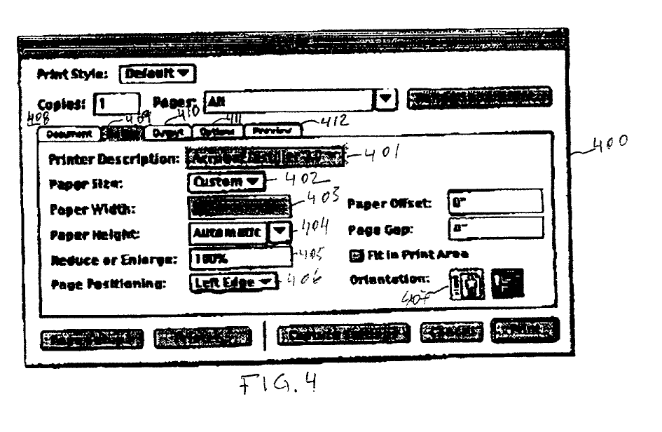

FIG. 3 shows a screen in Quark Xpress that results when a graphical digital content element is opened in Quark Xpress. This screen is characterized by a screen display 300, folder tabs “Document” 301, “Setup” 302, “Output” 303, “Options” 304 and “Preview” 305. Under the “Document” tab 301 menu screen, for the purposes of this embodiment of the present invention, it is preferable to leave the settings in the “Default” mode. As shown in FIG. 4 The display 400 when the “Setup” tab 302 is toggled is characterized by the headings “Printer Description” 401, “Paper Size” 402, “Paper Width” 403, “Paper Height” 404, “Reduce or Enlarge” 405, “Page Positioning” 406 and “Orientation” 407 folder tab “Document” folder tab “Setup” 409, folder tab “Output”, folder tab “Options 411, and folder tab “Preview” 412. Under the “Setup” tab 302 menu screen shown in FIG. 4, it is preferable to select the following settings:

Printer Description: Acrobat Distiller 3.0

Paper Size: Custom

Paper Width: Extract from document set up window and copy information.

Orientation: As per layout.

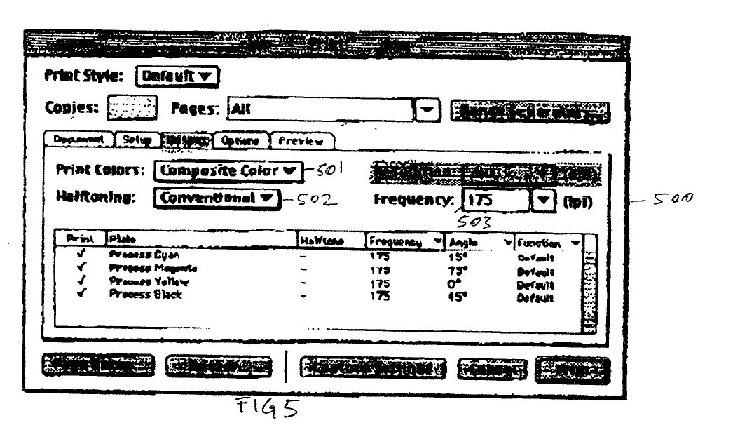

As shown in FIG. 5, when the “Output” tab 303 of FIG. 3 is selected, a screen 500 results characterized by the headings “Print Colors” 501, “Halftoning” 502, and “Frequency” 503. In screen 500 the following options should be selected:

Print Colors: Grayscale (default)

Halftoning: Conventional (default)

Resolution: 2400

Frequency: 175 lpi

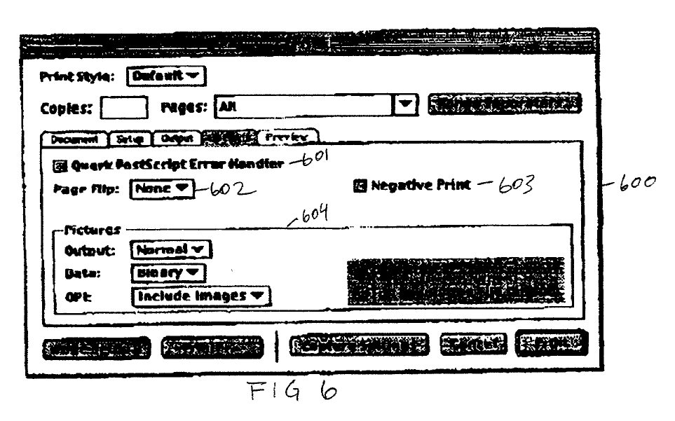

When the “Options” tab 304 in FIG. 3 is selected, menu screen 600 of FIG. 6 results. Screen 600 is characterized by the headings “Quark Postscript Error Handler” 601 “Page Flip” 602 Negative Print” 603 and a sub screen “Pictures” 604. All default settings in screen 600 should be selected. Additionally the following settings should be ensured:

Overprint EPS Black

Full Resolution TIFF output

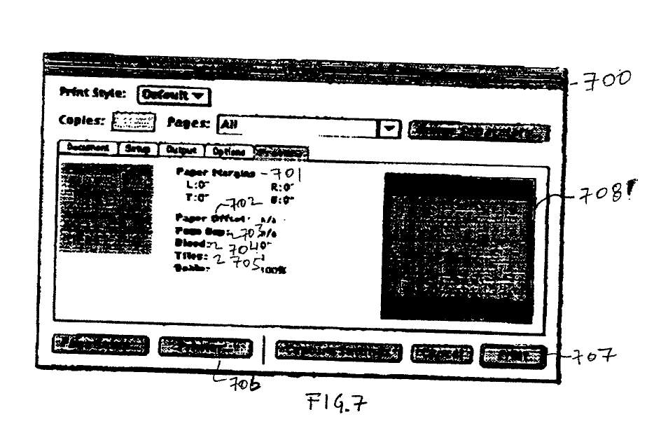

When the above described settings have been established the “Preview” tab 305 in FIG. 3 is selected, which generates screen 700 of FIG. 7. Screen 700 is characterized by headings “Paper Margins” 701, “Paper Offset” 702, “Page Size” 703, “Bleed” 704, “Files 705, a button labeled “Printer” 706 a button labeled “Print” 707 and a “Destination Area” 708. Here, it is necessary to check to ensure that the selected element under preparation (Cd booklet, spine, etc,) fits the specified page size. Following verification of proper fitment on the specified page size, the printer button/option 706 is selected from the Print Dialog box 707 shown in screen 700 of FIG. 7. From the “Destination Area” 708 the “File” option is selected from the “Print Dialogue” Box 708 and from the resultant drop down menu, “Save” is selected. When “Save” is selected the following options should be selected:

Format: Postscript Job

Binary Level 2 Only

Font Inclusion: All

Name document: select name with ps extension

After the above settings have been established “Save” is selected again which returns the user to the print dialogue box shown in 708 once again. At this point the “Print” button 707 is selected again. The selection of print at this stage creates a postscript file for the element under preparation.

The created postscript file is subsequently used to create both the printable and viewable components of the element under preparation. The process detailed above for the creation of a postscript file for an individual archive element is repeated for every element (CD booklet, spine, inlay etc.) of the graphic digital content archive or source that is necessary to create the graphic package for a corresponding digital audio recording.

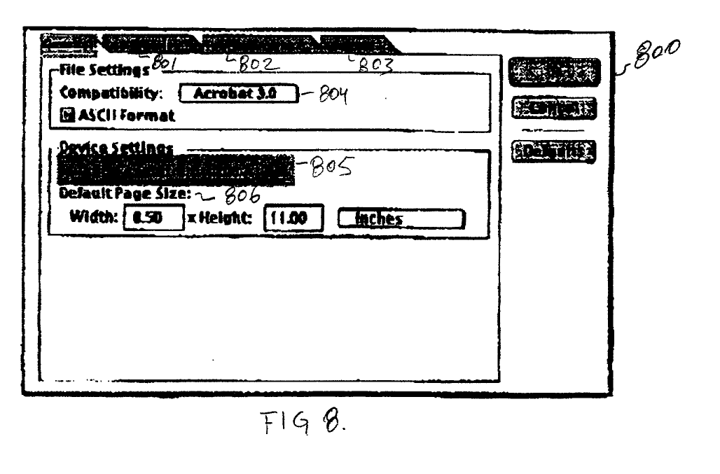

The next step in the preparation of the graphic digital content in the archive or source is to create a PDF file from the created postscript files for each element under preparation using the Acrobat Distiller software program. To proceed further it is necessary to launch the Acrobat Distiller software and as is shown in FIG. 8, the “Distiller” pull down menu screen 800 is generated on launch of the program. The screen 800 is characterized by folder tab “General” 801, folder tab “Compression” 802, folder tab “Font Embedding” 803 and folder tab “Advanced” 804. To begin with the “General” tab 801 is selected. The resultant screen is characterized by headings “Compatibility” 804, Default Resolution” 805, and “Default Page Size 806. The following job options are selected for each of these headings:

Compatibility: Acrobat 3.0,

Default Resolution: 300 dpi

Default page size: 8.5″×11″

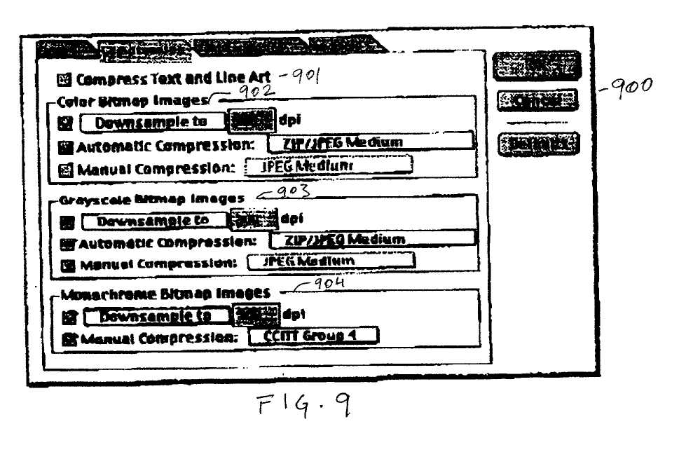

The next step in Acrobat Distiller and with reference to FIGS. 8 and 9 is the selection of the “Compression” tab 802 in FIG. 8. This results in menu screen 900 in FIG. 9. This menu screen is characterized by headings “Compress Text and Line Art” 901, “Color Bitmap Images” 902, “Grayscale Bitmap Images” 903 and “Monochrome Bitmap Images” Under this menu, the following settings are required:

Deselect Compress text and Line Art

Under Color Bitmap images:

a. Select Downsample to: 300 dpi;

b. Select Automatic Compression: ZIP/Jpeg Med.

Under Grayscale bitmap images:

c. Select Downsample to: 300 dpi;

d. Select Automatic Compression: ZIP/Jpeg Med.

Under Monochrome bitmap images:

Select Downsample to 300 dpi;

Select Automatic Compression: ZIP/Jpeg Med.

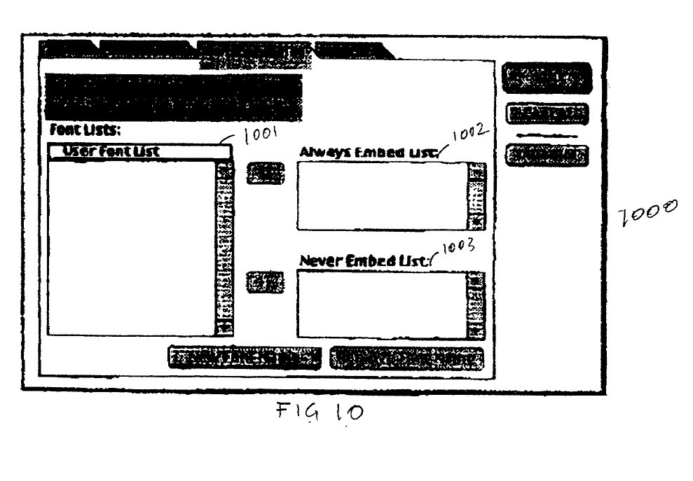

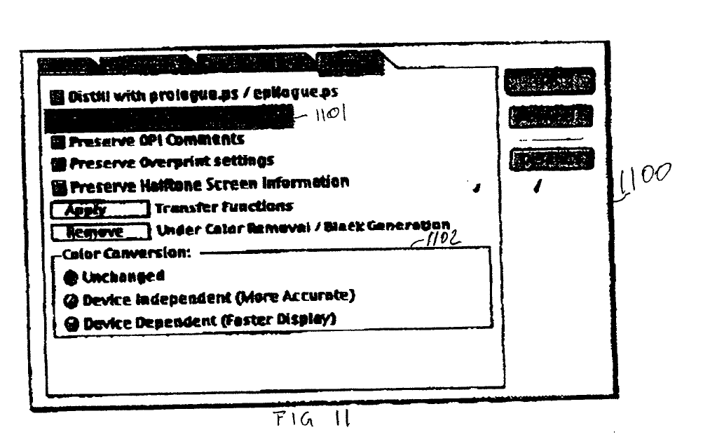

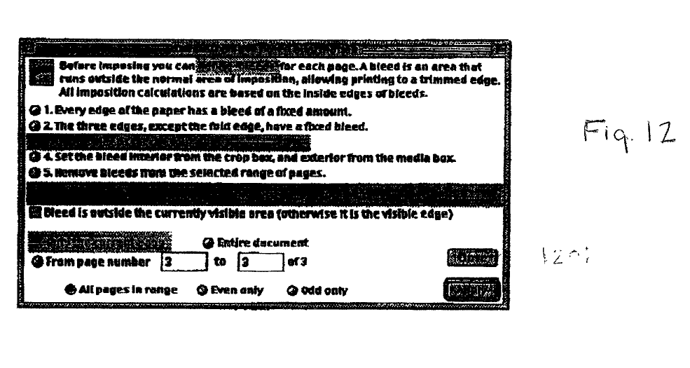

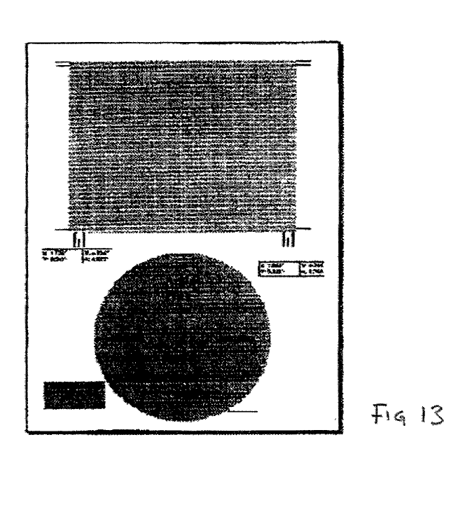

Turning next to FIGS. 8 and 10, following the settings under the “Compression” tab menu 802, the “Font Embedding” tab menu 803 is selected. The selection of folder tab menu 803 generates screen 1000. Screen 1000 is characterized by the headings “User Font List” 1001, “Always Embed List” 1002, and “Never Embed List” 1003. Under this menu, it is necessary to select “Embed all fonts” from the “Always Embed List” 1002. Next, and with reference to FIGS. 8 and 11, the “Advanced” tab menu 804 is selected in Acrobat Distiller. This selection generates screen 1100. Screen 1100 is characterized by headings “CMYK Images to RGB” 1101 and “Color Conversion” 1102. Under this menu, it is necessary to select:

CMYK images to RGB, and

Color Conversion: Unchanged.

Under this menu, once the settings detailed above are completed, “Okay” is selected from the Job Option Dialog box. At this point the settings in Acrobat Distiller are complete and PDF files can now be created in Acrobat Distiller from the Postscript files previously created in Quark Xpress.

To create a PDF file in Acrobat Distiller, it is necessary to open the Postscript file created in Quark Xpress corresponding to the element under process. For example, by opening the “CD Booklet” element generated as a postscript file in Quark Xpress in Acrobat Distiller, a corresponding PDF file is created. The file created is then saved as a five digit numbered file with a “.pdf” extension. For example: 63579.pdf.

The PDF file creation process in Acrobat Distiller is repeated for every element previously created as a postscript file in Quark Xpress, thereby creating corresponding PDF files consisting of, for example:

CD booklet Outside

CD booklet Inside

CD Inlay Outside

CD Inlay Inside (if provided)

Following the creation of the PDF files in Acrobat Distiller, Respective Viewable and Printable files can be created in Acrobat Exchange. As a first step towards this end, as shown in FIG. 1201, the “Crop Pages” command is chosen from the Document Pull Down menu. This command is used to crop pages manually, using onscreen trim marks. Next, “Insert Pages” is selected from the Document pull down menu. This command allows selection of each PDF file individually for insertion. Following the insertion of each individual PDF file, the “Crop Pages” command is used to manually trim each individual page and finally “Save As” is selected from the File pull down menu. In the “Save As” dialog box that results, the following selections are required:

Rename file: Selection Number.view.pdf

Select “optimize”,

Select “Security”,

Select: “Security Options”,

Specify Password To: Change security Options

Select: Do Not Allow printing, Changing the Document, Selecting text and Graphics, Adding or Changing Notes and Form Fields.

After all selections are made in the “Save As” dialog box, Choose OK to save the viewable PDF file. This process is repeated for each PDF file created in Acrobat Exchange. Upon completion, the assembly of files created serves as an on screen CD insert, followed by a tray inlay as the last page.

The final step in creating a viewable component in accordance with the present invention is a process commonly known as “flattening”. This process requires the conversion of all the individual viewable PDF files into one integrated viewable composite PDF file. This is accomplished combining and integrating all of the original PDF files per the naming convention:

“Selection Number”.pdf

Once an integrated composite viewable PDF is created, the next step is to create a Printable Component.

With reference to FIG. 1300, in order to create a Printable Component, the composite PDF file created above must be opened. From the Document pull down menu “Delete pages” is selected. This command is used to delete all pages except for ones that contain the desired graphic content such as the CD booklet Front and Back page(s) and the CD Tray/inlay. For simplicity, it is desirable to create a single combination page for the printable file that contains all the elements of the graphic digital content

Once the CD front is assembled “Crop Pages” is selected from the Document pull down menu and the steps described above for cropping pages are followed. For the best results, it is desirable that all crops extend to just outside the bleed indicators on all sides.

Following the cropping procedure, “Save As” is selected from the File pull down menu. The desired options are selected, and the file is saved according to the following convention:

e. Selection Number.Print.pdf

At this point, the printable component is now complete and Acrobat Exchange can be closed.

In another embodiment of the present invention a combination page can be prepared for printing. A combination is page composed of all the prepared elements of the graphical digital content disposed on one page and printable as a single sheet.

The next step is to obtain a printed copy of the prepared graphic digital content. To accomplish this Acrobat Reader must be launched, and the composite viewable PDF previously created in Acrobat Exchange opened in Acrobat Reader. This step allows the user to inspect the file prior to printing. Once the file is deemed satisfactory, the printable component is opened, and after an initial inspection the file can be printed. Printing of the prepared graphic digital content should be performed on suitable quality and preformatted paper for ease of final assembly of prepared graphic elements. Preformatting may include for example prefabricated perforations for ease of separation or creasing to facilitate folding of the printed product.

To verify the accuracy of the printed product, the printed version of the graphic digital content should be compared to an identical commercially distributed product for accuracy, if desired.

The printing of the prepared graphic digital content is the final step of the methodology of a preferred embodiment of the present invention. After all processing is completed, the directory and sub file created for the preparation of the graphic digital content of the accessed archive should have a single folder containing Quark Xpress files (for archiving), Postscript files (for archiving) and PDF files (for archiving).

To complete the assembly of a digital audio recording and the corresponding printed graphic that replicates that found in the conventional retail stream, a purchaser or user would need to further procure an appropriate container in which the audio media and the graphic media can be assembled and combined to form a finished product.

In some instances it may be desirable to limit the process of the present invention to the creation of only a viewable file to provide users with only a preview of the graphic content corresponding to a digital audio recording.

While the present invention has been described with reference to a specific embodiment and specific software packages, this description is merely illustrative of the invention and not to be construed as limiting the invention. Various modifications may occur to those skilled in the art without departing from the true spirit and scope of the invention as defined by the appended claims.

What is claimed is:

1. A method for preparing graphical content associated with corresponding digital audio content, comprising:
receiving said graphical content associated with said corresponding audio digital content from a digital database; and
preparing said graphical content for packaging with said corresponding digital audio content by implementing at least one format conversion.

2. The method according to claim 1, wherein said receiving step comprises downloading said graphical content from said digital database in a format compatible with a first commercial software program.

3. The method according to claim 2, wherein said first commercial software program includes Quark Xpress.

4. The method according to claim 1, wherein said preparing step comprises manipulating said graphical content by the application of at least one of two commercial software programs.

5. The method according to claim 4, wherein said two commercial software programs include Quark Xpress and Acrobat Distiller.

6. The method according to claim 1, wherein said at least one format conversion comprises converting said digital graphical content into postscript files and converting said postscript files into PDF files.

7. The method according to claim 1, wherein said at least one format conversion comprises:
utilizing a first software program to manipulate said digital graphical content:
creating postscript files corresponding to said digital graphical content;
manipulating said postscript files corresponding to said graphical content utilizing a second software program;
creating PDF files corresponding to said digital graphical content; and
printing said PDF files.

8. The method according to claim 7, wherein said first software program includes Quark Xpress.

9. The method according to claim 7, wherein said second software program includes Acrobat Distiller.

10. An apparatus for preparing graphical content associated with corresponding digital audio content comprising:
means for receiving said digital graphical content; and
means for preparing said digital graphical content by implementing at least one format conversion.

11. The apparatus according to claim 10, wherein said means for receiving said digital graphical content comprises a personal computer executing a first software application.

12. The apparatus according to claim 11, wherein said first software application includes Quark Xpress.

13. The apparatus according to claim 10, wherein said means for preparing said digital graphical content comprises a personal computer executing at least one of two software applications.

14. The apparatus according to claim 13, wherein said two software applications include Quark Xpress and Acrobat Distiller.

15. An apparatus for preparing graphical content associated with corresponding digital audio content comprising:
a first module receiving said graphical content; and
a second module preparing said graphical content for packaging with said corresponding digital audio content by implementing at least one format conversion.

16. The apparatus according to claim 15, wherein said first module comprises a first software program.

17. The apparatus according to claim 16, wherein said first software program includes Quark Xpress.

18. The apparatus according to claim 16, wherein said second module comprises a second software program.

19. The apparatus according to claim 18, wherein said second software program includes Acrobat Distiller.

20. An interactive data conversion system comprising:
a digital database, said digital database including graphical content and corresponding digital audio content;
a first server coupled to the digital database and hosting a website via which a user can access the digital database;
a personal computer couplable to the first server via a public computer network, said personal computer including:
a first module receiving said graphical content associated with said corresponding digital audio content; and
a second module preparing the graphical digital content for packaging with the corresponding audio digital content by implementing at least one format conversion.

21. The apparatus according to claim 20, wherein said first module comprises a first software program.

22. The apparatus according to claim 21, wherein said first software program includes Quark Xpress.

23. The apparatus according to claim 20, wherein said second module comprises a second software program.

24. The apparatus according to claim 23, wherein said second software program includes Acrobat Distiller.

25. A method for transmitting media to a consumer over a public computer network comprising:
transmitting a digital media file over the computer network to a user's personal computer in response to a user's request for the digital media file; and
transmitting a graphics file associated with the digital media file to the user's personal computer over the computer network.

26. The method according to claim 25, further comprising receiving the digital media file and the graphics file at the user's personal computer.

27. The method according to claim 26, further comprising converting the graphics file to a printable format after receiving it.

28. The method according to claim 26, further comprising storing the digital media file on a computer readable medium.

29. The method according to claim 28, further comprising printing the graphics file and attaching the printed graphics to the computer readable medium.
